(19) United States
(12) Patent Application Publication
(10) Pub. No.: US 2025/0141553 A1
(43) Pub. Date: May 1, 2025

(54) SYSTEM AND METHOD FOR FREQUENCY LOCKING NODES IN OPTICAL NETWORKS

(71) Applicant: Infinera Corp., San Jose, CA (US)

(72) Inventor: Christopher Fludger, Nuremberg (DE)

(21) Appl. No.: 18/932,005

(22) Filed: Oct. 30, 2024

Related U.S. Application Data
(60) Provisional application No. 63/546,406, filed on Oct. 30, 2023.

(51) Int. Cl. H04B 10/272; H04B 10/40; H04B 10/50

(52) U.S. Cl. CPC H04B 10/272; H04B 10/40; H04B 10/503

(57) ABSTRACT

Optical networks and methods including a method comprising sending, utilizing a first-hub laser in a first hub node, sub-carriers to a second leaf node; determining, with the second leaf node, laser frequency changes of the first-hub laser based on movement in frequency of at least one received sub-carriers from the first hub node; adjusting a second-leaf laser of the second leaf node to follow the laser frequency changes of the first-hub laser; determining, with the second hub node, laser frequency changes of the second-leaf laser based on movement in frequency of at least one sub-carrier received from the second leaf node, thereby determining the laser frequency changes of the first-hub laser; and adjusting a second-hub laser of the second hub node to follow the laser frequency changes of the second-leaf laser, and thereby to follow the laser frequency changes of the first-hub laser.

### CROSS-REFERENCE TO RELATED APPLICATIONS

This application claims priority to the provisional patent application identified by U.S. Ser. No. 63/546,406, titled “Secondary and Tertiary References for Frequency Locking Hub-nodes”, filed Oct. 30, 2023, the entire content of which is hereby expressly incorporated herein by reference.

### BACKGROUND

Optical networking is a communication means that utilizes signals encoded in light to transmit information (e.g., data) as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-)generation, and optical add/drop multiplexing (OADM). The most widely adopted Layer 1/Layer 0 transport networking technologies today, referred to as Optical Transport Networks (OTN), are based on ITU-T standards. Both these classes of networks are connection-oriented and circuit-switched in nature.

Internet traffic at the network edge continues to see considerable growth, driven by sectors such as edge computing, mobile front-haul and PON overlay networks. In Access and Metro market segments, traffic is mainly Hub-and-Spoke and the capacity demand from edge customers may change dynamically. An optical transceiver that allows point-to-multi-point (P2MP) trans-mission removes the expense of electrical aggregation equipment and adds the ability to reconfigure and allocate bandwidth-on-demand. This creates a more efficient network and reduces truck-rolls to remote sites.

Accordingly, there is a need for systems and methods that create Digital sub-carrier (DSC) based transmission that allows the hub overall capacity to be increased without replacement of leaf equipment. This increase may take the form of a replacement hub module which supports higher capacity through additional DSCs, or a parallel hub module to form a continuum of subchannels, for example. Additionally, an identical guard-band between all DSCs may be used and the DSCs from each hub may be arbitrarily allocated and reallocated depending upon traffic load.

### SUMMARY OF THE INVENTION

Optical transport networks, network elements, and methods of use are disclosed herein, including a method comprising sending, utilizing a first-hub laser in a first hub node in an optical network, sub-carriers to a first leaf node and a second leaf node in the optical network; receiving, with the second leaf node, the sub-carriers from the first hub node; determining, with the second leaf node, laser frequency changes of the first-hub laser based on movement in frequency of the received sub-carriers from the first hub node; adjusting a second-leaf laser of the second leaf node to follow the laser frequency changes of the first-hub laser; sending, to a second hub node in the optical network, from the second leaf node, and subsequent to adjusting the second-leaf laser, at least one sub-carrier; receiving, with the second hub node, the at least one sub-carrier from the second leaf node; determining, with the second hub node, laser frequency changes of the second-leaf laser based on movement in frequency of the at least one sub-carrier from the second leaf node, thereby determining the laser frequency changes of the first-hub laser; and adjusting a second-hub laser of the second hub node to follow the laser frequency changes of the second-leaf laser, and thereby to follow the laser frequency changes of the first-hub laser.

The method may comprise sending, utilizing the second-hub laser in the second hub node, subsequent to adjusting the second-hub laser, sub-carriers to a third leaf node; receiving, with the third leaf node, the sub-carriers from the second hub node; determining, with the third leaf node, laser frequency changes of the second-hub laser based on movement in frequency of the sub-carriers from the second hub node; and adjusting a third-leaf laser of the third leaf node to follow the laser frequency changes of the second-hub laser, and thereby to follow the laser frequency changes of the first-hub laser.

The method may comprise receiving, with the first leaf node, the sub-carriers from the first hub node; determining, with the first leaf node, laser frequency changes of the first-hub laser based on the received sub-carriers; and adjusting a first-leaf laser of the first leaf node to follow the laser frequency changes of the first-hub laser. The method may comprise sending, to a third hub node in the optical network, from the first leaf node, and subsequent to adjusting the first-leaf laser, at least one sub-carrier; receiving, with the third hub node, the at least one sub-carrier from the first leaf node; determining, with the third hub node, laser frequency changes of the first-leaf laser based on movement in frequency of the at least one sub-carrier from the first leaf node, thereby determining the laser frequency changes of the first-hub laser; and adjusting a third-hub laser of the third hub node to follow the laser frequency changes of the first-leaf laser, and thereby to follow the laser frequency changes of the first-hub laser.

In accordance with the present disclosure, optical networks are described including an optical network comprising: a first hub node comprising a first-hub transceiver comprising a first-hub laser configured to generate and transmit sub-carriers; one or more optical fibers connected to the first hub node and configured to carry the sub-carriers; a second leaf node connected by the one or more optical fibers to the first hub node and comprising a second-leaf transceiver configured to receive one or more of the sub-carriers from the first hub node and transmit one or more of the sub-carriers, the second-leaf transceiver comprising a second-leaf laser, wherein the second leaf node is configured to adjust the second-leaf laser to follow the laser frequency changes of the first-hub laser based on determining movement in frequency of the received sub-carriers; and a second hub node connected by the one or more optical fibers to the second leaf node and comprising a second-hub transceiver configured to transmit and receive one or more sub-carriers to and from the second leaf node, the second-hub transceiver comprising a second-hub laser, wherein the second hub node is configured to adjust the second-hub laser to follow the laser frequency changes of the second-leaf laser, and thereby to follow the laser frequency changes of the first-hub laser, based on determining movement in frequency of the received sub-carriers.

The optical network may comprise a third leaf node comprising a third-leaf transceiver configured to receive one or more of the sub-carriers from the second hub node and transmit one or more of the sub-carriers, the third-leaf transceiver comprising a third-leaf laser, wherein the third leaf node is configured to adjust the third-leaf laser to follow the laser frequency changes of the second-hub laser based on determining movement in frequency of the received sub-carriers, and thereby to follow the laser frequency changes of the first-hub laser.

In some embodiments, the optical network may comprise a first leaf node connected by the one or more optical fibers to the first hub node and comprising a first-leaf transceiver configured to receive one or more of the sub-carriers from the first hub node and transmit one or more of the sub-carriers, the first-leaf transceiver comprising a first-leaf laser, wherein the first leaf node is configured to adjust the first-leaf laser of the first leaf node to follow laser frequency changes of the first-hub laser based on determining movement in frequency of the received sub-carriers. The optical network may comprise a third hub node connected by the one or more optical fibers to the first leaf node and comprising a third-hub transceiver configured to transmit and receive one or more sub-carriers to and from the first leaf node, the third-hub transceiver comprising a third-hub laser, wherein the third hub node is configured to adjust the third-hub laser to follow the laser frequency changes of the first-leaf laser, and thereby to follow the laser frequency changes of the first-hub laser, based on determining movement in frequency of the received sub-carriers.

Embodiments of the above techniques include methods, apparatus, systems, and computer program products. One such computer program product is suitably embodied in a non-transitory machine-readable medium that stores instructions executable by one or more processors. The instructions are configured to cause the one or more processors to perform the above-described actions.

The details of one or more embodiments of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1A is a diagrammatic view of hardware forming an exemplary optical network constructed in accordance with the present disclosure.

FIG. 1B is another diagrammatic view of the hardware forming an exemplary optical network of FIG. 1A constructed in accordance with the present disclosure.

FIG. 2 is a diagrammatic view of an exemplary leaf node constructed in accordance with the present disclosure.

FIG. 3 is a diagrammatic view of an exemplary hub node constructed in accordance with the present disclosure.

FIG. 4 is a diagrammatic view of portions of an exemplary optical network in use constructed in accordance with the present disclosure.

FIG. 5 is a diagrammatic representation of exemplary sub-carriers sent by a first hub node and a second hub node in accordance with the present disclosure.

FIG. 6 is a diagrammatic representation of exemplary sub-carriers received by leaf nodes in accordance with the present disclosure.

FIG. 7 is a diagrammatic representation of exemplary subcarriers sent by hub nodes in accordance with the present disclosure.

FIG. 8 is a diagrammatic representation of exemplary subcarriers received by leaf nodes in accordance with the present disclosure.

FIG. 9 is a diagrammatic representation of exemplary subcarriers received by leaf nodes in accordance with the present disclosure.

FIG. 10 is a diagrammatic representation of exemplary subcarriers received by leaf nodes in accordance with the present disclosure.

FIG. 11 is a diagrammatic representation of exemplary subcarriers received by leaf nodes in accordance with the present disclosure.

FIG. 12 is a diagrammatic representation of exemplary subcarriers received by leaf nodes in accordance with the present disclosure.

FIG. 13 a diagrammatic representation of exemplary subcarriers received by leaf nodes in accordance with the present disclosure.

FIG. 14 a flow chart of an exemplary method in accordance with the present disclosure.

FIG. 15 a diagrammatic representation of another exemplary optical network in accordance with the present disclosure.

### DETAILED DESCRIPTION

The following detailed description refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment”, “an embodiment”, or “some embodiments” means that a particular element, feature, structure, or characteristic described in connection with the embodiment is included in at least one embodiment and may be used in conjunction with other embodiments. The appearances of the phrase “in one embodiment” or “in some embodiments” in various places in the specification are not necessarily all referring to the same embodiment.

Further, the phrase “based on” is intended to mean “based, at least in part, on” unless explicitly stated otherwise.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like.

Software may include one or more processor-executable instructions that when executed by one or more components (e.g., a processor) cause the component to perform a specified function. It should be understood that the algorithms described herein may be stored on one or more non-transitory processor-readable mediums, such as a memory. Exemplary non-transitory memory may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

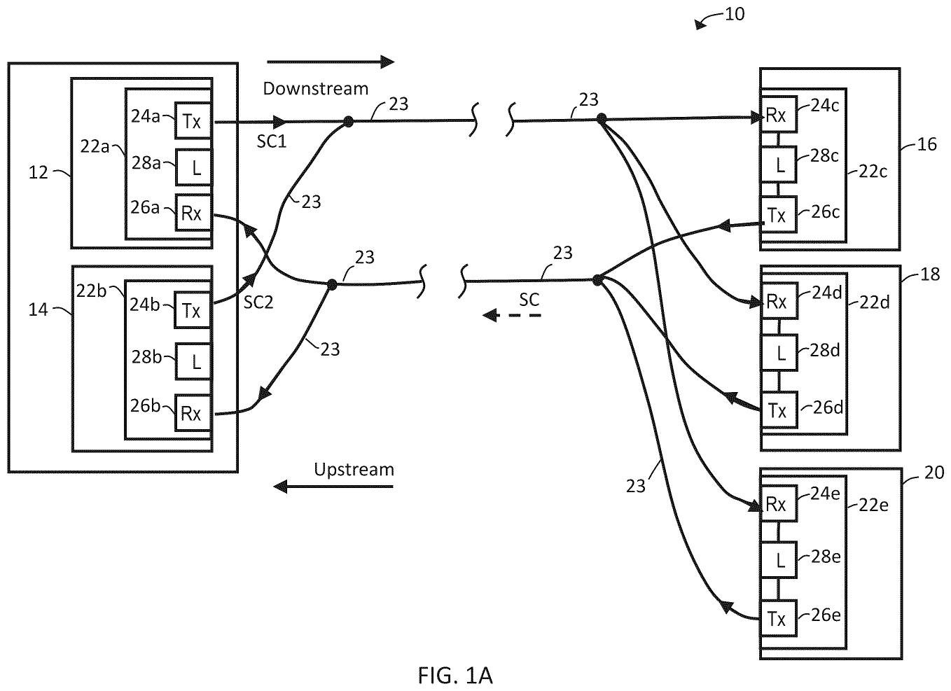

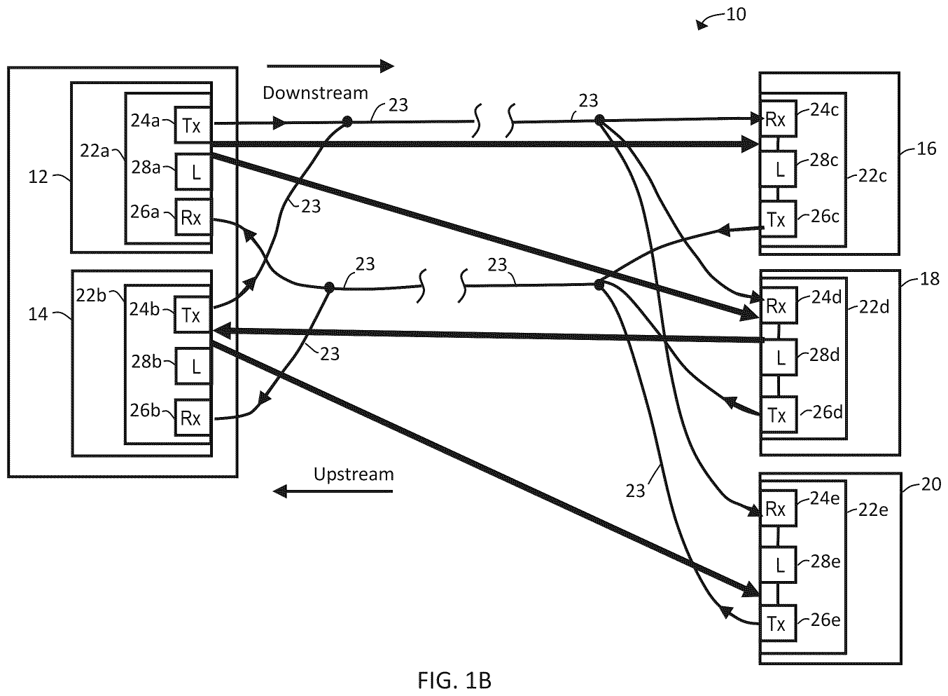

Referring now to the drawings and in particular to FIG. 1A, shown therein is a diagrammatic view of an exemplary embodiment of an optical transport network 10 (hereinafter, the “optical network 10”) in which frequency locking may be implemented. The optical network 10 may comprise a first hub node 12 and a second hub node 14 (which may, along with any other hub nodes in the optical network 10, be referred to in general as hub nodes) and a first leaf node 16 and a second leaf node 18 (which may, along with any other leaf nodes in the optical network 10, be referred to in general as leaf nodes). In some embodiments, the optical network 10 may comprise a third leaf node 20. Further, it will be understood that the number of hub nodes and leaf nodes are shown for illustration purposes, and, as described herein, the optical network may have a different quantity of hub nodes and/or leaf nodes. The first hub node 12, the second hub node 14, the first leaf node 16, the second leaf node 18, and the third leaf node 20, in the optical network 10 may be referred to, in general, as nodes.

Further, for purposes of discussion, the optical network 10 is shown with a downstream direction from the hub nodes to the leaf nodes and with an upstream direction from the leaf nodes to the hub nodes.

Each of the hub nodes and the leaf nodes may comprise a transceiver 22 having a transmitter 24 and a receiver 26 controlled by one or more laser 28. Sub-Carriers (SC) may be transmitted from the transmitters 24 of one of the nodes to one or more of the receivers 26 of the other nodes via optical fibers 23 (not all of which are labeled in FIG. 1A, for clarity). In some embodiments, one or more of the sub-carriers may be configured to carry between ten Gigabits of data per second and thirty Gigabits of data per second. In some embodiments, one or more of the sub-carriers may be configured to carry approximately twenty-five Gigabits of data per second.

The generation of laser beams for use as optical data channel signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference. Additionally, US 2021/0111802 A1, entitled “HUB-LEAF LASER SYNCHRONIZATION”, published Apr. 15, 2021, including descriptions of hub and leaf nodes, is also hereby fully incorporated by reference in its entirety herein.

Though the term optical fiber is used herein, a person having ordinary skill in the art will understand that the network elements in the optical network 10 may be connected via an optical link, an optical channel, an optical super-channel, a super-channel group, an optical carrier group, a set of spectral slices, an optical control channel, an optical data channel (e.g., sometimes referred to herein as “BAND”), and/or any other optical signal transmission link.

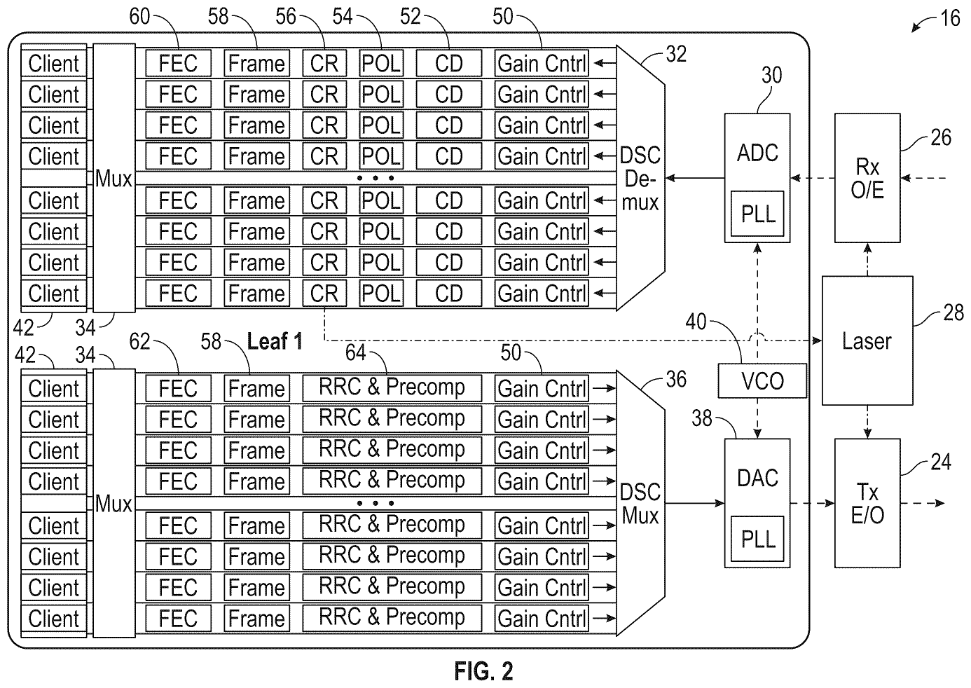

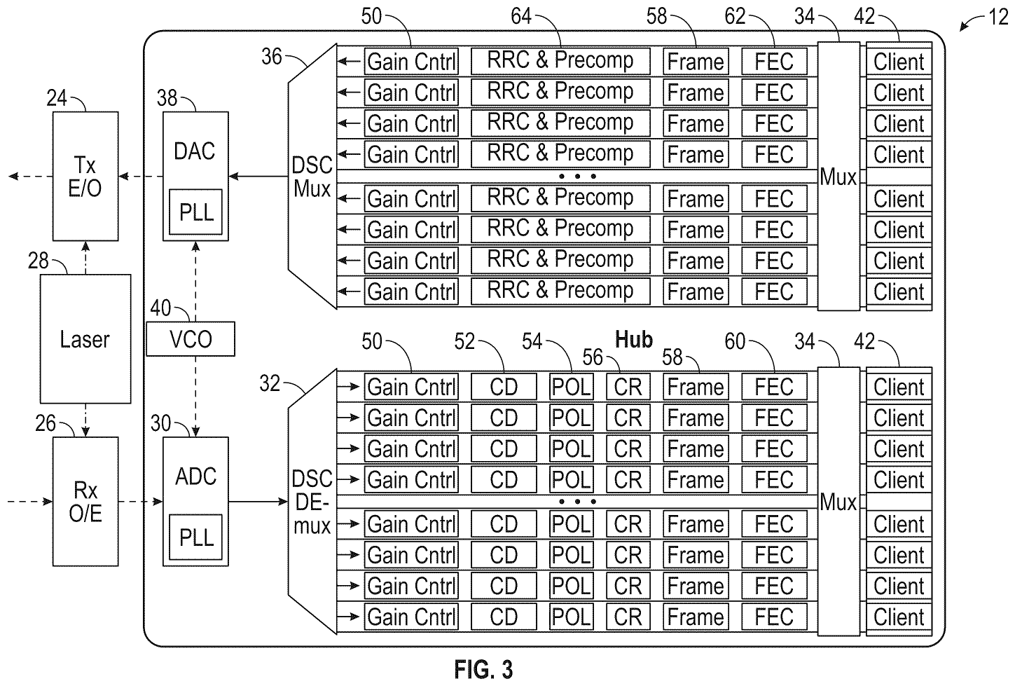

Shown in FIG. 2 and FIG. 3 are components of an exemplary leaf node (illustrated as the first leaf node 16 in FIG. 2) and an exemplary hub node (illustrated as the first hub node 12 in FIG. 3). The nodes may include one or more of: an analog-to-digital converter (ADC) 30, a DSC Demux 32, Mux 34 (such as a Mux on the receiver side and a Mux on the transmitter side), DSC Mux 36, a digital-to-analog converter (DAC) 38, and a voltage-controlled oscillator (VCO) 40.

The nodes may receive, process, and transmit client data streams 42. The nodes may utilize one or more of: gain controls 50, CD 52, polarization modules 54, carrier recovery (CR) components 56, frames 58, FEC decoders 60, FEC encoders 62, and RRC & precomp 64.

As will be understood by a person having ordinary skill in the art, the hub nodes and leaf nodes may comprise more or fewer components and/or circuitry. Further, the processing of digital to optical and optical to digital signals is well understood and, as such, will not be described in detail herein.

In the exemplary embodiment shown in FIG. 1A, the first hub node 12 comprises a first-hub transceiver 22a comprising a first-hub laser 28a configured to generate and transmit sub-carriers (SC1), such as to one or more of: the first leaf node 16, the second leaf node 18, and the third leaf node 20. The second hub node 14 comprises a second-hub transceiver 22b comprising a second-hub laser 28b configured to generate and transmit sub-carriers (SC2), such as to one or more of: the first leaf node 16, the second leaf node 18, and the third leaf node 20.

The first leaf node 16 comprises a first-leaf transceiver 22c comprising a first-leaf laser 28c configured to generate and transmit sub-carriers, such as to one or more of the first hub node 12 and the second hub node 14. The receiver 26c of the first-leaf transceiver 22c is configured to receive sub-carriers, such as from one or more of the first hub node 12 and the second hub node 14.

The second leaf node 18 comprises a second-leaf transceiver 22d comprising a second-leaf laser 28d configured to generate and transmit sub-carriers, such as to one or more of the first hub node 12 and the second hub node 14. The receiver 26d of the second-leaf transceiver 22d is configured to receive sub-carriers, such as from one or more of the first hub node 12 and the second hub node 14.

The third leaf node 20 comprises a third-leaf transceiver 22e comprising a third-leaf laser 28e configured to generate and transmit sub-carriers, such as to one or more of the first hub node 12 and the second hub node 14. The receiver 26e of the third-leaf transceiver 22e is configured to receive sub-carriers, such as from one or more of the first hub node 12 and the second hub node 14.

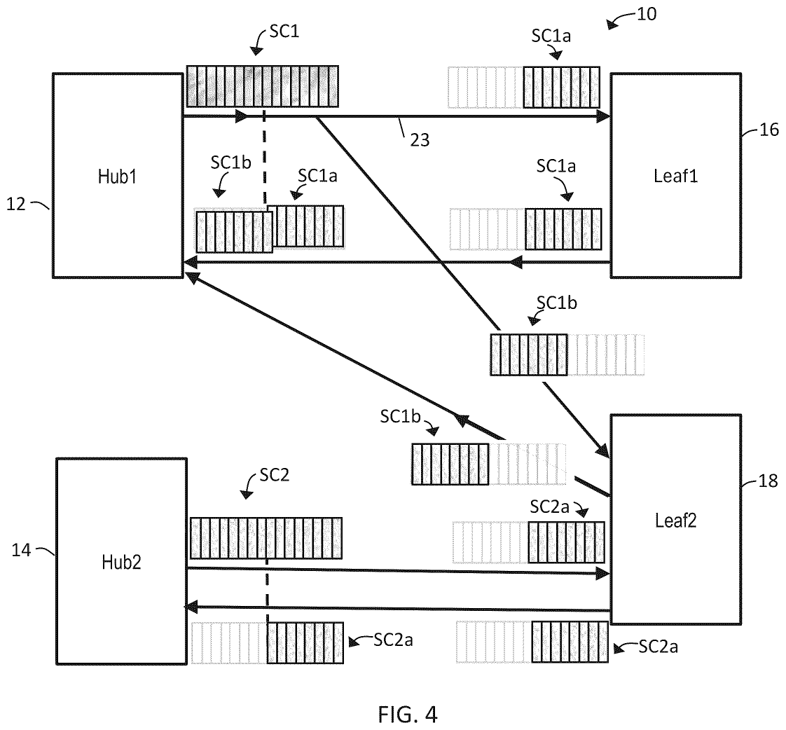

As shown in FIG. 4, initially, the first hub node 12 may transmit sub-carriers (SC1) to the first leaf node 16 and the second leaf node 18. The first leaf node 16 may receive a first subset (SC1a) of the sub-carriers and the second leaf node 18 may receive a second subset (SC1b) of the sub-carriers. However, when the first leaf node 16 transmits the first subset (SC1a) of the sub-carriers and the second leaf node 18 transmits the second subset (SC1b) of the sub-carriers back to the first hub node 12, the frequencies of the first subset (SC1a) of the sub-carriers and the second subset (SC1b) of the sub-carriers may be shifted, which may cause the first subset (SC1a) of the sub-carriers and the second subset (SC1b) of the sub-carriers to collide, which causes errors in receiving data carried by the sub-carriers.

To prevent these collisions, the first-leaf laser 28c may be adjusted to follow the laser frequency of the first-hub laser 28a by monitoring and/or determining changes in frequency of the received first subset SC1a of the sub-carriers sent by the first-hub laser 28a of the first hub node 12.

Determining laser frequency changes of a sending-laser (that is, the laser 28 of the node that is transmitting one or more of the sub-carriers) may be based on movement in frequency of a single one of the received sub-carriers from the sending-laser or on movement in frequency of two or more of the received sub-carriers from the sending-laser.

In some embodiments, determining laser frequency changes of the sending-laser based on movement in frequency of the received sub-carriers comprises utilizing one or more of the carrier recovery components 56 (see FIGS. 2 and 3) within the receiving node to recover the laser frequency changes of the sending-laser from the received sub-carriers. The carrier recovery components 56 may include a carrier phase estimator which tracks phase changes. The average difference in phase may be considered as the frequency offset, that is, the laser frequency change, as is known to those having ordinary skill in the art. One example of carrier recovery components 56 is described in US 2021/0111802 A1, entitled “HUB-LEAF LASER SYNCHRONIZATION”, published Apr. 15, 2021, which is hereby incorporated by reference in its entirety herein.

Likewise, the second-leaf laser 28d may be adjusted to follow the laser frequency of the first-hub laser 28a by monitoring changes in frequency of the received second subset SC2 of the sub-carriers sent by the first hub node 12. In this scenario, the first hub node 12 is considered to be the “primary reference”, which the first leaf node 16 and the second leaf node 18 follow for frequency changes (which may be referred to as frequency locking).

In the example shown in FIGS. 1A and 4, the second hub node 14 is not receiving sub-carriers from the first hub node 12, and so cannot directly follow the frequency changes of the first-hub laser 28a of the first hub node 12. However, the second hub node 14 is configured to send and receive sub-carriers (SC2) to and from the second leaf node 18. Therefore, in order for the second hub node 14 to follow the frequency changes of the first-hub laser 28a of the first hub node 12, the second hub node 14 may determine frequency changes of the second-leaf laser 28d of the second leaf node 18 which is frequency locked with the first hub node 12 to determine the frequency changes of the first hub node 12. In such a scenario, the second leaf node 18 may be referred to as a “secondary reference” while the first hub node 12 may be referred to as a “primary reference”.

More specifically, the second hub node 14 may be configured to adjust the second-hub laser 28b to follow the laser frequency changes of the second-leaf laser 28d of the second leaf node 18, and thereby to follow the laser frequency changes of the first-hub laser 28a of the first hub node 12 since the second-leaf laser 28d is configured to follow the first-hub laser 28a, based on determining movement in frequency of one or more sub-carriers SC2a received from the second leaf node 18. In such a scenario, the second hub node 14 may be referred to as “frequency locked” to the second leaf node 18 and to the first hub node 12. Subsequent to adjusting the second-hub laser 28b, the second hub node 14 may be configured to send one or more sub-carriers SC2a to the second leaf node 18 using the adjusted frequency.

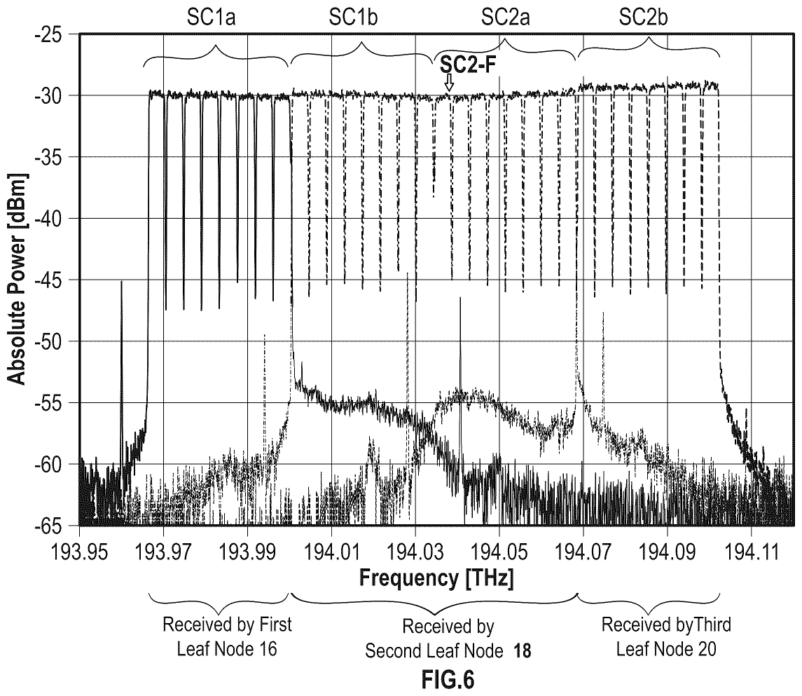

In some embodiments, as shown in FIG. 6, the second hub node 14 may be configured to adjust the second-hub laser 28b to follow the laser frequency changes of the second-leaf laser 28d of the second leaf node 18 based on determining movement in frequency of a single sub-carrier, such as a first sub-carrier SC2-F received from the second leaf node 18. In some embodiments, the second hub node 14 may be configured to adjust the second-hub laser 28b to follow the laser frequency changes of the second-leaf laser 28d of the second leaf node 18 based on determining movement in frequency of two or more sub-carriers received from the second leaf node 18.

Returning now to FIG. 1A, additionally, the third leaf node 20 may be configured to adjust the third-leaf laser 28e to follow the laser frequency changes of the second-hub laser 28b of the second hub node 14, based on determining movement in frequency of the received sub-carriers, and thereby to follow the laser frequency changes of the first-hub laser 28a of the first hub node 12 when the second-hub laser 28b is adjusted to follow the laser frequency changes of the first-hub laser 28a.

Further, though two hub nodes and three leaf nodes are shown and described for exemplary purposes, it will be understood that additional hub nodes and leaf nodes may also be used in the optical network 10, and may likewise be frequency locked to the first hub node 12 utilizing the same configuration described in regards to the second hub node 14.

In some embodiments, as shown in FIG. 1B, network configuration instructions may be communicated via an out-of-band channel. For example, network configuration instructions may be communicated via an out-of-band channel from the first hub node 12 to the first leaf node 16 and the second leaf node 18. Further, network configuration instructions may be communicated via an out-of-band channel from the second leaf node 18 to the second hub node 14. Additionally, network configuration instructions may be communicated via an out-of-band channel from the second hub node 14 to the third leaf node 20, for example.

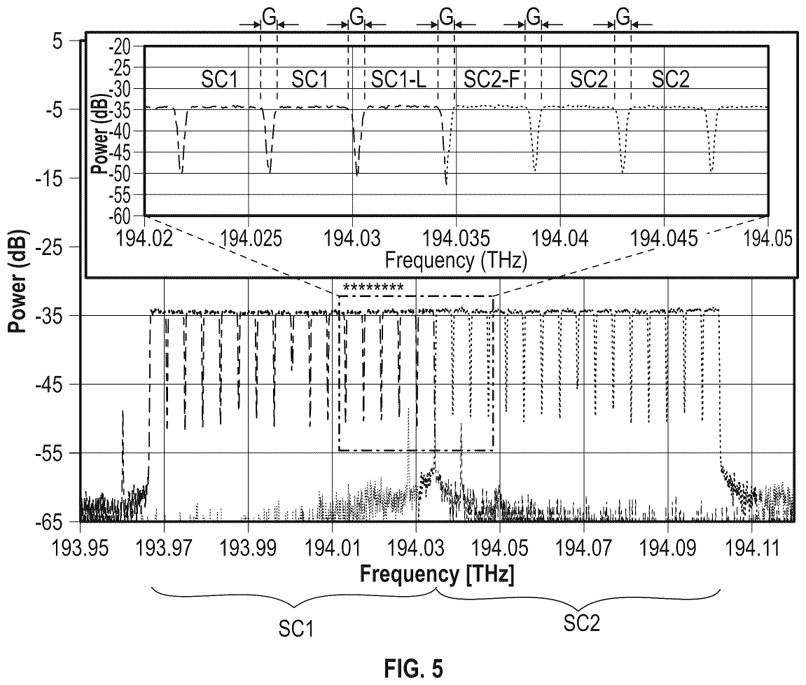

As shown in FIG. 5, frequency locking the second hub node 14 to the first hub node 12 results in a close continuation in frequency of the subcarriers SC1 from the first hub node 12 and the subcarriers SC2 from the second hub node 14.

For example, in some embodiments, a gap (G) in frequency (a guard-band) between each of the sub-carriers SC1 from the first hub node 12, between each of the sub-carriers SC2 of the second hub node 14, and between a last one SC1-L of the sub-carriers SC1 from the first hub node 12 and a first one SC2-F of the sub-carriers SC2 of the second hub node 14 may be approximately the same size. For example, the gaps G may be between 100 MHz and 500 MHz. In one embodiment, the gap G is approximately 300 MHz.

As a result of these closely spaced sub-carriers from multiple hub nodes, the optical network 10 may be configured to easily split the sub-carriers to different leaf nodes. For example, sub-carriers from both the first hub node 12 and the second hub node 14 can be sent to the second leaf node 18. For example, as shown in the subcarrier chart of FIG. 6, the optical network 10 may be configured such that the first leaf node 16 receives a first subset SC1a of subcarriers from the first hub node 12, the third leaf node 20 receives a second subset SC2b of subcarriers from the second hub node 14, and the second leaf node 18 receives both a first subset SC2a of subcarriers from the second hub node 14 and a second subset SC1b of subcarriers from the first hub node 12.

It will be understood that in some embodiments, the first leaf node 16 may transmit the first subset SC1a of subcarriers from the first hub node 12 back to the first hub node 12; the second leaf node 18 may transmit the first subset SC2a of subcarriers from the second hub node 14 back to the second hub node and may transmit the second subset SC1b of subcarriers from the first hub node 12 back to the first hub node; and the third leaf node 20 may transmit the second subset SC2b of subcarriers from the second hub node 14 back to the second hub node 14.

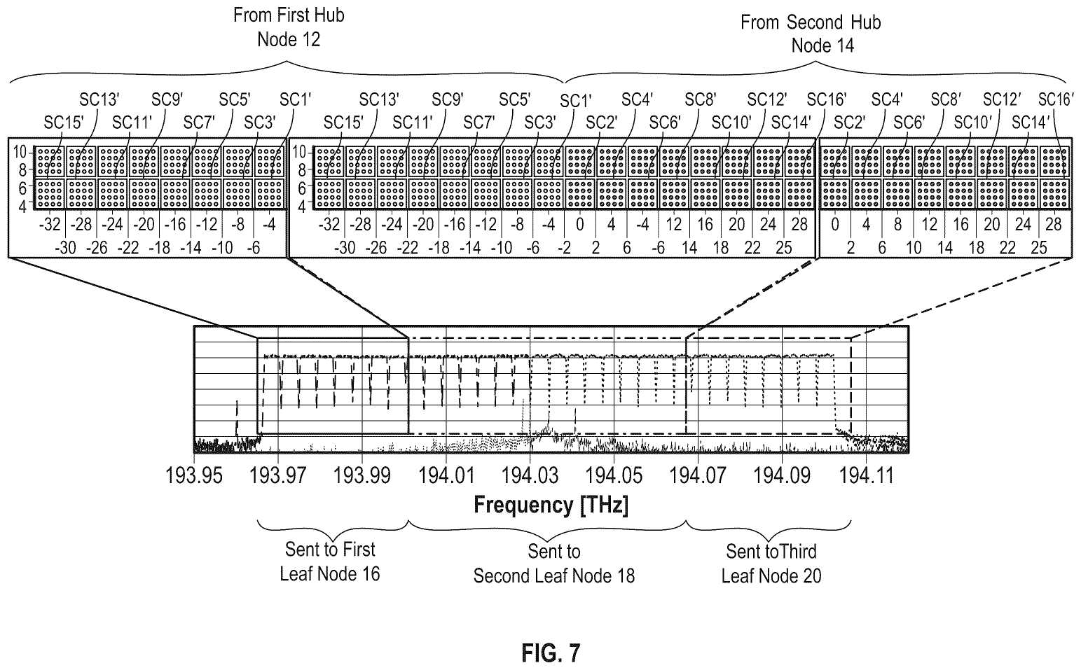

FIG. 7 further illustrates the example shown in FIGS. 5 and 6, from the perspective of the subcarriers as sent from the first hub node 12 and the second hub node 14 to the first leaf node 16, the second leaf node 18, and the third leaf node 20. FIG. 7 also includes constellation diagrams of sub-carriers SC1′-SC16′ from the perspective of the hub nodes, however, due to size limitations, the actual constellations are not shown.

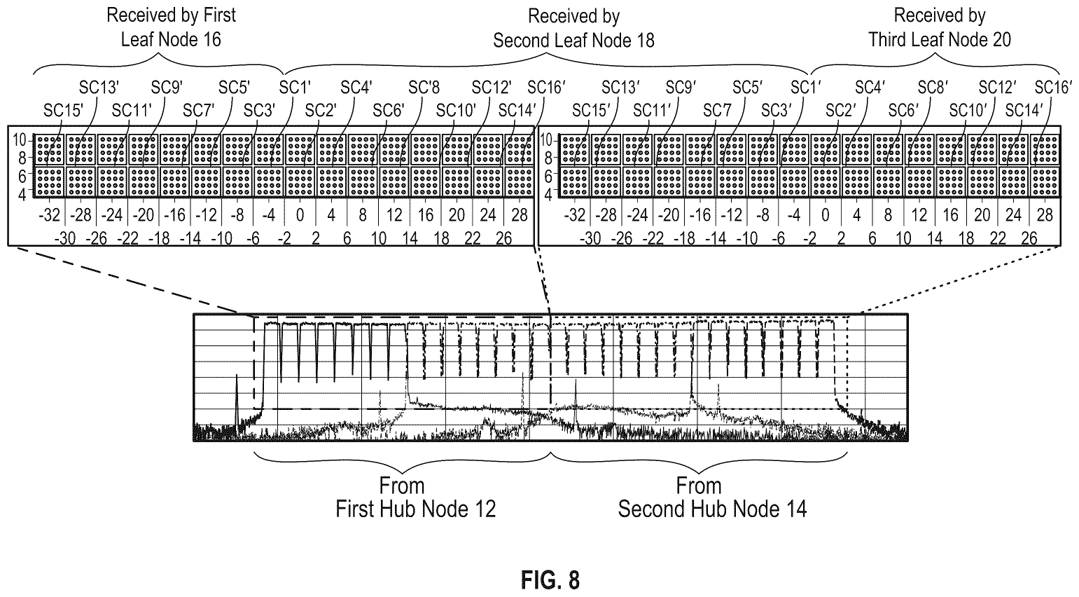

FIG. 8 further illustrates the example shown in FIGS. 5-7, from the perspective of the subcarriers as received by the first leaf node 16, the second leaf node 18, and the third leaf node 20. FIG. 8 also includes representations constellation diagrams of the sub-carriers SC1′-SC16′ from the perspective of the leaf nodes, however, due to size limitations, the actual constellations are not shown.

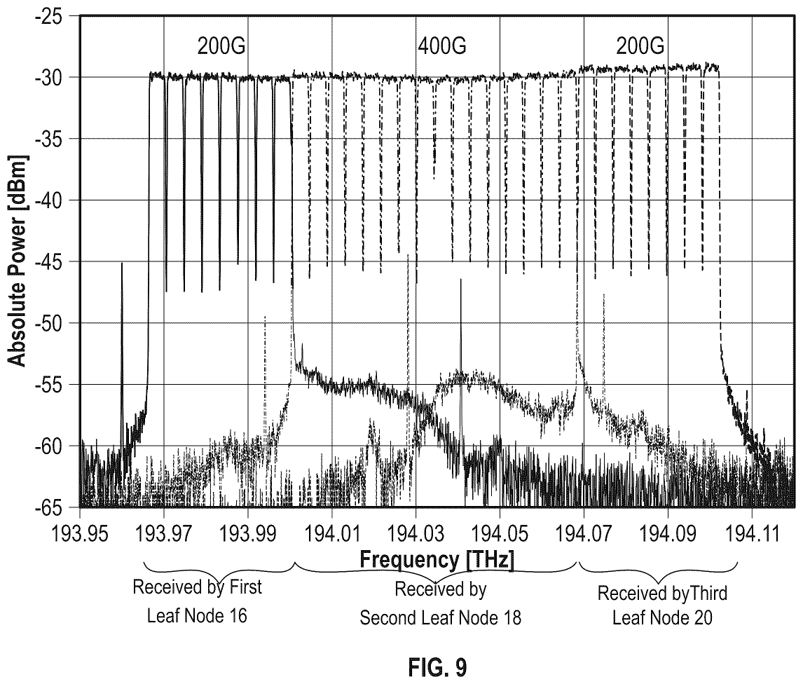

FIG. 9 illustrates an exemplary sub-carrier allocation for the first leaf node 16, the second leaf node 18, and the third leaf node 20, of 200 G, 400 G, and 200 G, respectively. Specifically, in this example, the first hub node 12 allocates sub-carriers to the first leaf node 16 to provide 200 G to the first leaf node 16 and allocates sub-carriers to the second leaf node 18 to provide 200 G to the second leaf node 18. The second hub node 14 allocates sub-carriers to the second leaf node 18 to also provide 200 G to the second leaf node 18 (for a total of 400 G to the second leaf node 18) and allocates sub-carriers to the third leaf node 20 to provide 200 G to the third leaf node 20.

Further, as a result of these closely spaced sub-carriers from multiple hub nodes, the optical network 10 may be configured to change the number of (the quantity of) sub-carriers provided to different ones of the leaf nodes in order to meet demands for more or less data streaming capacity and/or speed. In the downstream direction, the optical transmission does not need to be interrupted when reallocating the sub-carriers to different leaf nodes. The data capacity is simply switched to a different leaf node. In the upstream direction, one leaf node turns-off sub-carriers, followed by another leaf node turning-on sub-carriers. In systems without EDFA, switching may be performed quickly since adding and dropping channels does not lead to large power transients and the power of each sub-carrier can be individually set.

Examples of the optical network 10 in experimental use demonstrating changes in the sub-carriers provided to different ones of the leaf nodes will now be described. In these examples, the sub-carriers SC2 from the second hub node 14 are at higher frequencies that the frequencies of sub-carriers SC1 from the first hub node 12; however, it will be understood that different, fewer, or additional frequencies of sub-carriers may be used.

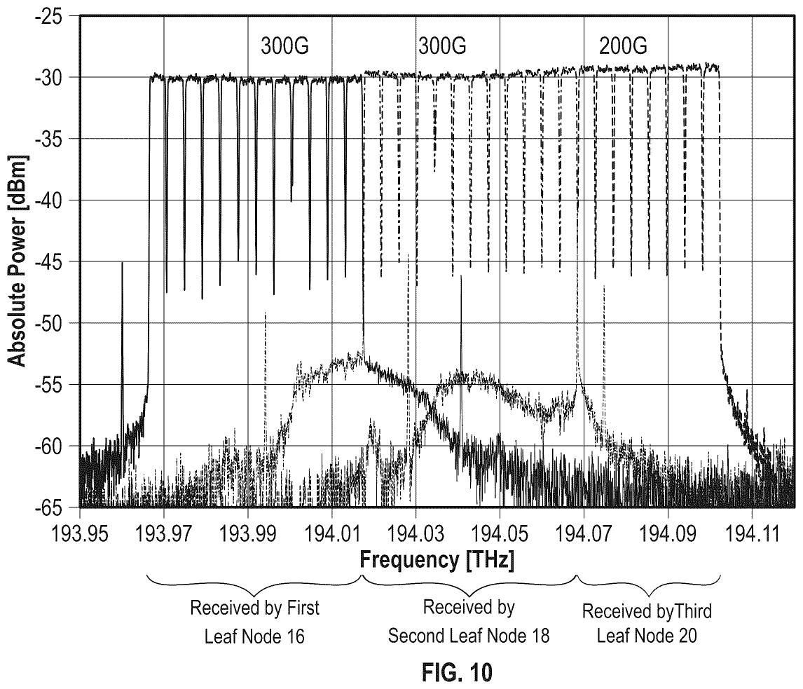

In a first example, shown in FIG. 10, the optical network 10 is configured to change from the first hub node 12 sending 200 G to the first leaf node 16 and sending 200 G to the second leaf node 18 (as shown in FIG. 9) to the first hub node 12 sending 300 G to the first leaf node 16 and 100 G to the second leaf node 18 by re-allocating sub-carriers from the second leaf node 18 to the first leaf node 16. In this example, the second hub node 14 continues to send 200 G to the second leaf node 18 and 200 G to the third leaf node 20.

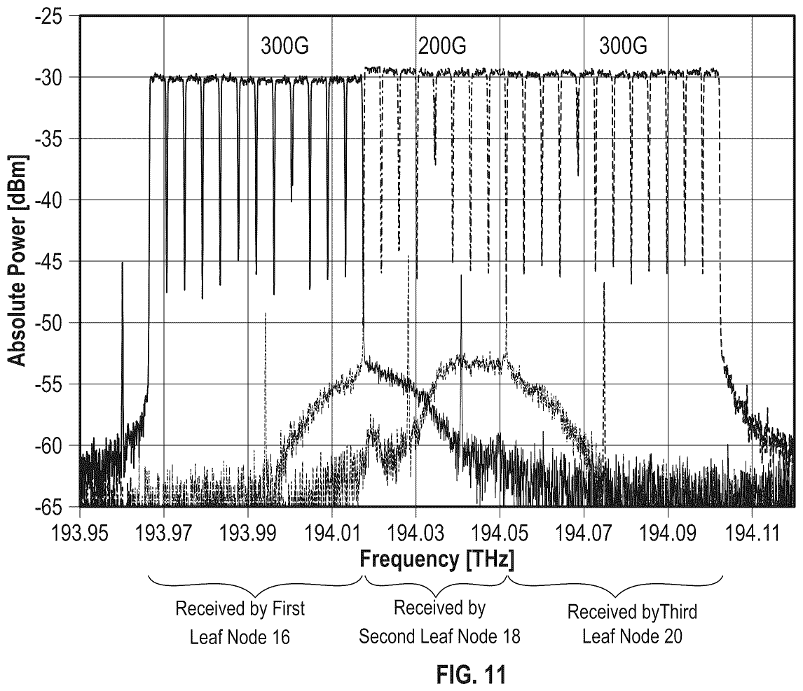

In a second example, shown in FIG. 11, the optical network 10 is configured to change from the second hub node 14 sending 200 G to the second leaf node 18 and sending 200 G to the third leaf node 20 (as shown in FIG. 10) to the second hub node 14 sending 100 G to the second leaf node 18 and sending 300 G to the third leaf node 20, by re-allocating sub-carriers from the second leaf node 18 to the third leaf node 20. In this example, the first hub node 12 continues to send 300 G to the first leaf node 16 and 100 G to the second leaf node 18.

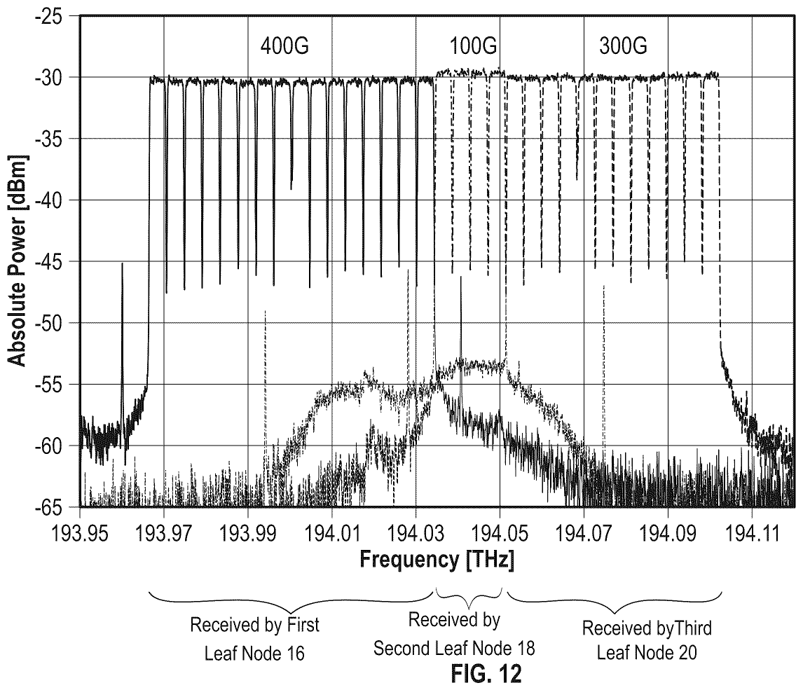

In a third example, shown in FIG. 12, the optical network 10 is configured to change from the first hub node 12 sending 300 G to the first leaf node 16 and 100 G to the second leaf node 18 (as shown in FIG. 11) to the first hub node 12 sending 400 G to the first leaf node 16 and nothing to the second leaf node 18 by re-allocating sub-carriers from the second leaf node 18 to the first leaf node 316. In this example, the second hub node 14 continues to send 100 G to the second leaf node 18 and 200 G to the third leaf node 20.

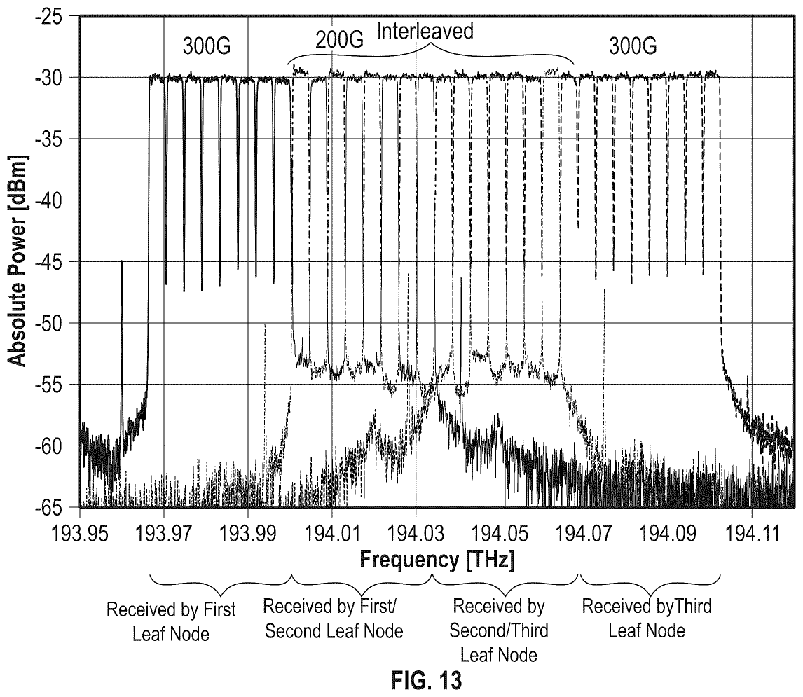

In a third example, shown in FIG. 13, the optical network 10 is configured to change which sub-carriers are provided to the leaf nodes from the hub nodes. In this example, the first hub node 12 changes from sending 400 G to the first leaf node 16 and nothing to the second leaf node 18 (as shown in FIG. 11) to sending 300 G to the first leaf node 16 and 100 G to the second leaf node 18 by re-allocating sub-carriers. Further, the second hub node 14 changes which of the particular sub-carriers are sent to the second leaf node 18 to continue to provide the 100 G to the second leaf node 18. However, in this example, 200 G of the sub-carriers are interleaved, such that every other sub-carrier is sent to a different one of the first leaf node 16 and second leaf node 18 for the first 100 G (which are eight sub-carriers from the first hub node 12) of the 200 G allocation, and such that every other sub-carrier is sent to a different one of the second leaf node 18 and the third leaf node 20 for the second 100 G (which are eight sub-carriers from the second hub node 14) of the 200 G allocation.

In this example, the sub-carriers are shown as interleaved every-other sub-carrier to a different leaf node, but each sub-carrier may be sent separately to any connected leaf node in any order and/or quantity.

The interleaving of the sub-carriers demonstrates that each sub-carrier is independent, with the potential to be allocated and reallocated by the sending hub node to independent leaf nodes, such as the first, second, and third leaf nodes 16, 18, 20 shown, and/or any other leaf node configuration and/or quantity.

The above-described examples are meant to explain how the optical network 10 may be utilized, however, it will be understood that many other variations of sub-carriers and amounts of data may be used.

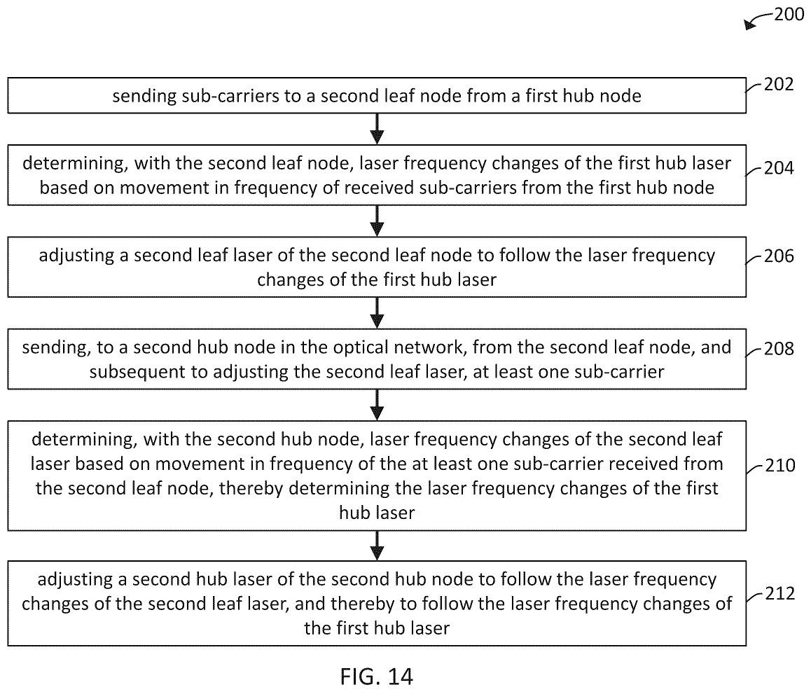

Turning now to FIG. 14, an exemplary method 200 of use is illustrated. The method 200 may comprise a step 202 of sending, utilizing the first-hub laser 28a in the first hub node 12 in the optical network 10, one or more sub-carriers to the second leaf node 18 in the optical network 10. The first hub node 12 may also send sub-carriers to the first leaf node 16.

The method may comprise receiving, with the second leaf node 18, the sub-carriers from the first hub node 12. The method 200 may comprise a step 204 of determining, with the second leaf node 18, laser frequency changes of the first-hub laser 28a of the first hub node 12 based on movement in frequency of the received sub-carriers from the first hub node 12; a step 206 of adjusting the second-leaf laser 28d of the second leaf node 18 to follow the laser frequency changes of the first-hub laser 28a of the first hub node 12; and a step 208 of sending, to the second hub node 14 in the optical network 10, from the second leaf node 18, and subsequent to adjusting the second-leaf laser 28d, at least one sub-carrier.

The method 200 may further comprise receiving, with the second hub node 14, the at least one sub-carrier from the second leaf node. The method 200 may comprise a step 210 of determining, with the second hub node 14, laser frequency changes of the second-leaf laser 28d based on movement in frequency of the at least one sub-carrier from the second leaf node 18, thereby determining the laser frequency changes of the first-hub laser 28a of the first hub node 12; and a step 212 of adjusting the second-hub laser 28b of the second hub node 14 to follow the laser frequency changes of the second-leaf laser 28d of the second leaf node 18, and thereby to follow the laser frequency changes of the first-hub laser 28a of the first hub node 12, since the second-leaf laser 28d of the second leaf node 18 follows the laser frequency changes of the first-hub laser.

In some embodiments, the method 200 may comprise sending, utilizing the second-hub laser 28b in the second hub node 14, subsequent to adjusting the second-hub laser 28b, one or more sub-carriers to the second leaf node 18 and/or the third leaf node 20.

In some embodiments, the method 200 may comprise sending, utilizing the second-hub laser 28b in the second hub node 14, subsequent to adjusting the second-hub laser 28b, sub-carriers to the third leaf node 20; receiving, with the third leaf node 20, the sub-carriers from the second hub node 14; determining, with the third leaf node 20, laser frequency changes of the second-hub laser 28b based on movement in frequency of the sub-carriers from the second hub node 14; and adjusting the third-leaf laser 28e of the third leaf node 20 to follow the laser frequency changes of the second-hub laser 28b of the second hub node 14, and thereby to follow the laser frequency changes of the first-hub laser 28a of the first hub node 12. Since the third leaf node 20 and the second leaf node 18 both are frequency locked to the first-hub laser 28a via the first hub node 12 and the second hub node 14, respectively, the result is an elimination of collisions of sub-carriers sent from the third leaf node 20 and the second leaf node 18 to the second hub node 14.

In some embodiments, the method 200 may comprise receiving, with the first leaf node 16, the sub-carriers from the first hub node 12; determining, with the first leaf node 16, laser frequency changes of the first-hub laser 28a based on the received sub-carriers; and adjusting a first-leaf laser 28c of the first leaf node 16 to follow the laser frequency changes of the first-hub laser 28a of the first hub node 12.

In some embodiments, the at least one sub-carrier from the first leaf node 16 is at higher frequencies that the frequencies of the at least one sub-carrier from the second leaf node 18. However, as previously discussed, the sub-carriers form the first leaf node 16 may be at lower frequencies or other frequencies than the examples shown.

In some embodiments, determining, with the second leaf node 18, laser frequency changes of the first-hub laser 28a based on movement in frequency of the received sub-carriers from the first hub node 12 is based on a single one of the received sub-carriers.

In some embodiments, determining, with the second leaf node 18, laser frequency changes of the first-hub laser 28a based on movement in frequency of the received sub-carriers from the first hub node 12 comprises utilizing one or more of the carrier recovery components 56 within the second leaf node 18 to recover the laser frequency changes of the first-hub laser 28a from the received sub-carriers.

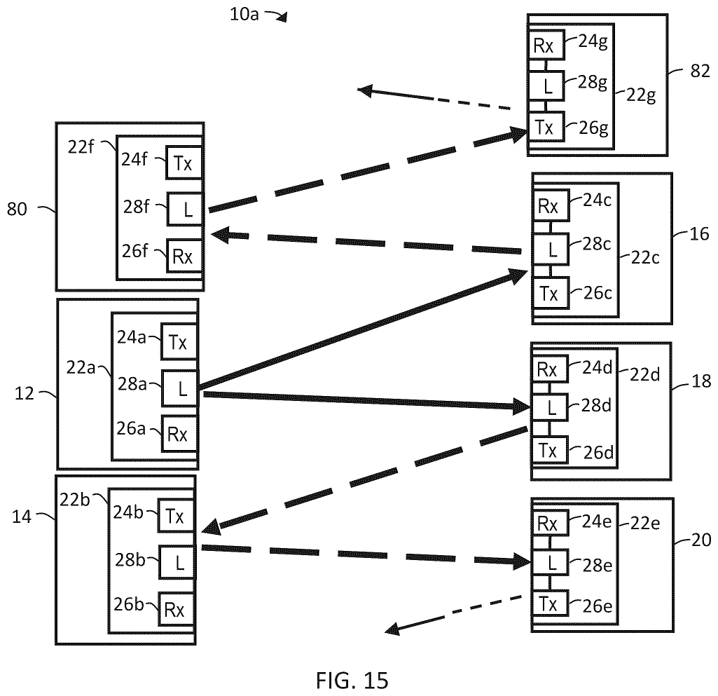

Turning now to FIG. 15, shown therein is another exemplary optical network 10a, similar to the optical network 10, except as described below. The exemplary optical network 10a may further comprise a third hub node 80 connected by the one or more optical fibers 23 to the first leaf node 16. The third hub node 80 may comprise a third-hub transceiver 22f having a transmitter 24f and a receiver 26f and one or more third-hub laser 28f. The third-hub transceiver 22f may be configured to transmit and receive one or more sub-carriers to and from the first leaf node 16. The third hub node 80 may be configured to adjust the third-hub laser 28f to follow the laser frequency changes of the first-leaf laser 28c of the first leaf node 16, and thereby to follow the laser frequency changes of the first-hub laser 28a, based on determining movement in frequency of the received sub-carriers.

The optical network 10a may further comprise a fourth leaf node 82 connected by the one or more optical fibers 23 to the third hub node 80. The fourth leaf node 82 comprises a fourth-leaf transceiver 22g comprising a fourth-leaf laser 28g configured to generate and transmit sub-carriers, such as to one or more of the third hub node 80. The fourth-leaf transceiver 22g of the fourth leaf node 82 comprises a receiver 26e configured to receive sub-carriers, such as from one or more of the third hub node 80.

The third-hub transceiver 22f may be configured to transmit and receive one or more sub-carriers to and from the fourth leaf node 82.

The fourth leaf node 82 may be configured to follow the laser frequency changes of the third-hub laser 28f of the third hub node 80, and thereby to follow the laser frequency changes of the first-hub laser 28a, based on determining movement in frequency of the received sub-carriers from the third hub node 80, such as in a similar method as that described above regarding the other nodes frequency locking.

In the optical network 10a shown in FIG. 15, the first hub node 12 may be referred to as the primary reference for laser frequency changes. The first leaf node 16 and the second leaf node 18 may be referred to as secondary references, as the first leaf node 16 and the second leaf node 18 directly determine and follow the laser frequency changes of the first-hub laser 28a of the first hub node 12 (the primary reference) based on determining movement in frequency of the received sub-carriers from the first hub node 12.

In this scenario, the second hub node 14 may be referred to as a tertiary reference, since the second hub node 14 determines and follows the laser frequency changes of the second-leaf laser 28d of the second leaf node 18 (a secondary reference) based on determining movement in frequency of the received sub-carriers from the second leaf node 18.

Likewise, in the optical network 10a shown in FIG. 15, the third hub node 80 may be referred to as a tertiary reference, since the third hub node 80 determines and follows the laser frequency changes of the first-leaf laser 28c of the first leaf node 16 (a secondary reference) based on determining movement in frequency of the received sub-carriers from the first leaf node 16.

In a similar manner, if additional hub nodes were present or added, the third leaf node 20 and the fourth leaf node 82 may be referred to as a quaternary reference for any additional hub nodes (not shown) receiving sub-carriers from the third leaf node 20 and the fourth leaf node 82. It will be understood that the configuration of the optical network 10a may be further expanded to include additional leaf nodes and/or hub nodes which may be frequency locked to the first-hub laser 28a of the first hub node 12 in a similar manner as to that described for the exemplary hub nodes and leaf nodes. These numbered-node references may be visualized as a “daisy chain” for purposes of frequency locking back to a primary reference, with each additional hub node utilizing a previously-linked leaf node as a step in the chain.

As applied to the exemplary optical network 10a shown in FIG. 15, in some embodiments, the method 200 described above may further comprise sending, to the third hub node 80 in the exemplary optical network 10a, from the first leaf node 16, and subsequent to adjusting the first-leaf laser 28c, at least one sub-carrier; receiving, with the third hub node 80, the at least one sub-carrier from the first leaf node 16; determining, with the third hub node 80, laser frequency changes of the first-leaf laser 28c of the first leaf node 16 based on movement in frequency of the at least one sub-carrier from the first leaf node 16, thereby determining the laser frequency changes of the first-hub laser 28a of the first hub node 12; and adjusting the third-hub laser 28f of the third hub node 80 to follow the laser frequency changes of the first-leaf laser 28c of the first leaf node 16, and thereby to follow the laser frequency changes of the first-hub laser 28a of the first hub node 12.

The method 200 may further comprise sending, to the fourth leaf node 82 in the exemplary optical network 10a, from the third hub node 80, and subsequent to adjusting the third-hub laser 28f, at least one sub-carrier; receiving, with the fourth leaf node 82, the at least one sub-carrier from the third hub node 80; determining, with the fourth leaf node 82, laser frequency changes of the third-hub laser 28f of the third hub node 80 based on movement in frequency of the at least one sub-carrier from the third hub node 80, thereby determining the laser frequency changes of the first-hub laser 28a of the first hub node 12; and adjusting the fourth-leaf laser 28g of the fourth leaf node 82 to follow the laser frequency changes of the third-hub laser 28f of the third hub node 80, and thereby to follow the laser frequency changes of the first-hub laser 28a of the first hub node 12.

It will be understood that one or more secondary reference, tertiary reference, quaternary reference, and so on, may be utilized in many different variations and architectures for optical networks in order to provide frequency locking beyond a direct connection to the primary reference node.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment.

What is claimed is:

1. A method, comprising:
sending, utilizing a first-hub laser in a first hub node in an optical network, sub-carriers to a first leaf node and a second leaf node in the optical network;
receiving, with the second leaf node, the sub-carriers from the first hub node;
determining, with the second leaf node, laser frequency changes of the first-hub laser based on movement in frequency of the received sub-carriers from the first hub node;
adjusting a second-leaf laser of the second leaf node to follow the laser frequency changes of the first-hub laser;
sending, to a second hub node in the optical network, from the second leaf node, and subsequent to adjusting the second-leaf laser, at least one sub-carrier;
receiving, with the second hub node, the at least one sub-carrier from the second leaf node;
determining, with the second hub node, laser frequency changes of the second-leaf laser based on movement in frequency of the at least one sub-carrier from the second leaf node, thereby determining the laser frequency changes of the first-hub laser; and
adjusting a second-hub laser of the second hub node to follow the laser frequency changes of the second-leaf laser, and thereby to follow the laser frequency changes of the first-hub laser.

2. The method of claim 1, comprising:
sending, utilizing the second-hub laser in the second hub node, subsequent to adjusting the second-hub laser, one or more sub-carriers to the second leaf node.

3. The method of claim 1, comprising:
sending, utilizing the second-hub laser in the second hub node, subsequent to adjusting the second-hub laser, sub-carriers to a third leaf node;
receiving, with the third leaf node, the sub-carriers from the second hub node;
determining, with the third leaf node, laser frequency changes of the second-hub laser based on movement in frequency of the sub-carriers from the second hub node; and
adjusting a third-leaf laser of the third leaf node to follow the laser frequency changes of the second-hub laser, and thereby to follow the laser frequency changes of the first-hub laser.

4. The method of claim 1, comprising:
receiving, with the first leaf node, the sub-carriers from the first hub node;
determining, with the first leaf node, laser frequency changes of the first-hub laser based on the received sub-carriers; and
adjusting a first-leaf laser of the first leaf node to follow the laser frequency changes of the first-hub laser.

5. The method of claim 4, comprising:
sending, to a third hub node in the optical network, from the first leaf node, and subsequent to adjusting the first-leaf laser, at least one sub-carrier;
receiving, with the third hub node, the at least one sub-carrier from the first leaf node;
determining, with the third hub node, laser frequency changes of the first-leaf laser based on movement in frequency of the at least one sub-carrier from the first leaf node, thereby determining the laser frequency changes of the first-hub laser; and
adjusting a third-hub laser of the third hub node to follow the laser frequency changes of the first-leaf laser, and thereby to follow the laser frequency changes of the first-hub laser.

6. The method of claim 5, wherein the at least one sub-carrier from the first leaf node is at higher frequencies that the frequencies of the at least one sub-carrier from the second leaf node.

7. The method of claim 1, wherein determining, with the second leaf node, laser frequency changes of the first-hub laser based on movement in frequency of the received sub-carriers from the first hub node is based on a single one of the received sub-carriers.

8. The method of claim 1, wherein determining, with the second leaf node, laser frequency changes of the first-hub laser based on movement in frequency of the received sub-carriers from the first hub node comprises utilizing one or more carrier recovery components within the second leaf node to recover the laser frequency changes of the first-hub laser from the received sub-carriers.

9. The method of claim 1, wherein each sub-carrier is configured to carry between ten Gigabits of data per second and thirty Gigabits of data per second.

10. The method of claim 1, wherein a gap between the sub-carriers is between 100 MHz and 500 MHz.

11. An optical network, comprising:
a first hub node comprising a first-hub transceiver comprising a first-hub laser configured to generate and transmit sub-carriers;
one or more optical fibers connected to the first hub node and configured to carry the sub-carriers;
a second leaf node connected by the one or more optical fibers to the first hub node and comprising a second-leaf transceiver configured to receive one or more of the sub-carriers from the first hub node and transmit one or more of the sub-carriers, the second-leaf transceiver comprising a second-leaf laser, wherein the second leaf node is configured to adjust the second-leaf laser to follow the laser frequency changes of the first-hub laser based on determining movement in frequency of the received sub-carriers; and
a second hub node connected by the one or more optical fibers to the second leaf node and comprising a second-hub transceiver configured to transmit and receive one or more sub-carriers to and from the second leaf node, the second-hub transceiver comprising a second-hub laser, wherein the second hub node is configured to adjust the second-hub laser to follow the laser frequency changes of the second-leaf laser, and thereby to follow the laser frequency changes of the first-hub laser, based on determining movement in frequency of the received sub-carriers.

12. The optical network of claim 11, wherein the second hub node is configured to send, utilizing the second-hub laser in the second hub node and subsequent to adjusting the second-hub laser, one or more sub-carriers to the second leaf node.

13. The optical network of claim 11, comprising:
a third leaf node comprising a third-leaf transceiver configured to receive one or more of the sub-carriers from the second hub node and transmit one or more of the sub-carriers, the third-leaf transceiver comprising a third-leaf laser, wherein the third leaf node is configured to adjust the third-leaf laser to follow the laser frequency changes of the second-hub laser based on determining movement in frequency of the received sub-carriers, and thereby to follow the laser frequency changes of the first-hub laser.

14. The optical network of claim 11, comprising:
a first leaf node connected by the one or more optical fibers to the first hub node and comprising a first-leaf transceiver configured to receive one or more of the sub-carriers from the first hub node and transmit one or more of the sub-carriers, the first-leaf transceiver comprising a first-leaf laser, wherein the first leaf node is configured to adjust the first-leaf laser of the first leaf node to follow laser frequency changes of the first-hub laser based on determining movement in frequency of the received sub-carriers.

15. The optical network of claim 14, comprising:
a third hub node connected by the one or more optical fibers to the first leaf node and comprising a third-hub transceiver configured to transmit and receive one or more sub-carriers to and from the first leaf node, the third-hub transceiver comprising a third-hub laser, wherein the third hub node is configured to adjust the third-hub laser to follow the laser frequency changes of the first-leaf laser, and thereby to follow the laser frequency changes of the first-hub laser, based on determining movement in frequency of the received sub-carriers.

16. The optical network of claim 15, wherein the at least one sub-carrier from the first leaf node is at higher frequencies that the frequencies of the at least one sub-carrier from the second leaf node.

17. The optical network of claim 11, wherein determining, with the second leaf node, laser frequency changes of the first-hub laser based on movement in frequency of the received sub-carriers from the first hub node is based on a single one of the received sub-carriers.

18. The optical network of claim 11, wherein determining, with the second leaf node, laser frequency changes of the first-hub laser based on movement in frequency of the received sub-carriers from the first hub node comprises utilizing one or more carrier recovery components within the second leaf node to recover the laser frequency changes of the first-hub laser from the received sub-carriers.

19. The optical network of claim 11, wherein each sub-carrier is configured to carry between ten Gigabits of data per second and thirty Gigabits of data per second.

20. The optical network of claim 11, wherein a gap between the sub-carriers is between 100 MHz and 500 MHz.
